(19) United States
(12) Patent Application Publication
(10) Pub. No.: US 2025/0305877 A1
(43) Pub. Date: Oct. 2, 2025

(54) IMAGING DEVICE AND METHOD OF MULTI-SPECTRAL IMAGING

(71) Applicant: ams Sensors USA Inc., PLANO, TX (US)

(72) Inventors: Ananth TAMMA, BOISE, ID (US); Kevin TETZ, BOISE, ID (US); Scott JOHNSON, BOISE, ID (US)

(73) Assignee: ams Sensors USA Inc., PLANO, TX (US)

(21) Appl. No.: 18/865,968

(22) PCT Filed: May 16, 2023
(86) PCT No.: PCT/US2023/022333

§ 371 Date: Nov. 14, 2024

Related U.S. Application Data
(60) Provisional application No. 63/343,297, filed on May 18, 2022.

(51) Int. Cl. G01J 3/28; G01J 3/10; G01J 5/00; G01J 5/0806; G01J 5/40; H04N 23/11; H04N 25/131

(52) U.S. Cl. CPC G01J 3/2803; G01J 3/10; G01J 3/2823; G01J 5/0806; G01J 5/40; H04N 25/131; G01J 2005/0077; H04N 23/11

(57) ABSTRACT

An imaging device is specified, the imaging device including a detector array a plurality of pixels, the pixels including a plurality of subpixel types, a micromirror array with a plurality of mirror elements, and an internal light source, wherein at least one of the subpixel types is configured to detect a first radiation; the mirror elements are configured to deflect in response to a second radiation, the internal light source is configured to illuminate the detector array with a third radiation; at least one of the subpixel types is configured to detect the third radiation deflected by the micromirror array. Furthermore, a method of multi-spectral imaging is specified.

### CROSS-REFERENCE TO RELATED APPLICATIONS

The present application is a national stage entry from International Application No. PCT/US2023/022333, filed on May 16, 2023, published as International Publication No. WO 2023/224955 A1 on Nov. 23, 2023, and claims the benefit of U.S. Provisional Application No. 63/343,297, filed on May 18, 2022, all of which are incorporated by reference herein in their entireties.

### FIELD OF THE INVENTION

The present application relates to an imaging device and to a method of multi-spectral imaging.

### BACKGROUND OF THE INVENTION

CMOS image sensors are widely used for detection of radiation in the visible or near infrared spectral range with maximum detection wavelengths of at most 1100 nm. However, the silicon used as photosensitive material in these sensors is not sensitive to radiation in the longwave infrared spectral range so that these sensors cannot directly detect longwave infrared radiation for thermal imaging.

An object to be solved is to provide an imaging device that allows for imaging both in the visible and in the longwave infrared spectral range. Furthermore, a method is to be specified that allows for multi-spectral imaging.

These and other objects are obtained inter alia by an imaging device and a method according to the independent claims.

Further configurations and expediencies are the subject of the dependent claims.

An imaging device is specified.

### SUMMARY OF THE INVENTION

According to at least one embodiment of the imaging device the imaging device comprises a detector array with a plurality of pixels. The pixels in particular comprise a plurality of subpixel types. For example, the subpixel types differ from one another with respect to their spectral sensitivities.

For example, silicon is used as a photosensitive material of the detector array. Different spectral sensitivities for the subpixel types may be obtained by a filter array arranged on the detector array.

For example, three different subpixel types are sensitive in the visible spectral range. For example the detector array comprises subpixel types sensitive in the red, green and blue spectral range respectively for full-color imaging in the visible spectral range.

According to at least one embodiment of the imaging device, the imaging device comprises a micromirror array with a plurality of mirror elements. For example, the micromirror is a MEMS (micro-electromechanical system) based mirror. For example, the mirror elements are configured to deflect in response to longwave infrared radiation.

The longwave infrared radiation in particular includes radiation with a wavelength between 7 μm and 14 μm. Radiation in this spectral range includes radiation within the so-called third atmospheric window so that this wavelength range is particularly suited for thermal imaging.

According to at least one embodiment of the imaging device, the imaging device comprises an internal light source. For example, the internal light source is configured to emit radiation that is detectable by the detector array. For example, the radiation of the internal light source is in the ultraviolet visible or near infrared spectral range.

In this context, near infrared (NIR) in particular means radiation between 700 nm and 1100 nm inclusive. For example, a peak emission wavelength of the internal light source is at most 1100 nm or at most 1000 nm. In other words, the peak emission wavelength is smaller than the cutoff wavelength of silicon.

According to at least one embodiment of the imaging device, at least one of the subpixel types is configured to detect a first radiation. The first radiation comes from a scene to be detected by the imaging device.

According to at least one embodiment of the imaging device, the mirror elements are configured to deflect in response to a second radiation. The second radiation in particular includes larger wavelengths than the first radiation.

According to at least one embodiment of the imaging device, the internal light source is configured to illuminate the detector array with a third radiation. The third radiation may have a peak emission wavelength in the ultraviolet, visible or near infrared spectral range.

According to at least one embodiment of the imaging device, at least one of the subpixel types, for example exactly one or at least two or all of the subpixel types, is/are configured to detect the third radiation deflected by the micromirror array. Consequently both the first radiation and the third radiation can be detected by the same detector array, wherein the third radiation allows for obtaining an image corresponding to the second radiation.

In at least one embodiment of the imaging device, the imaging device comprises a detector with a plurality of pixels, wherein the pixels comprise a plurality of subpixel types. The imaging device further comprises a micromirror array with a plurality of mirror elements and an internal light source. At least one of the subpixel types is configured to detect a first radiation. The mirror elements are configured to deflect in response to a second radiation. The internal light source is configured to illuminate the micromirror array with a third radiation. At least one of the subpixel types is configured to detect the third radiation deflected by the micromirror array.

Thus, the imaging device uses the same detector array, for example a commercial CMOS imaging sensor in combination with a color filter array to simultaneously capture both visible and thermal images. For example full-color visible images are captured using pixels provided with color filters transmitting red, green and blue radiation respectively. The thermal images are captured by encoding the incident thermal image onto the light of the internal light source. The encoded radiation of the internal light source is detected using at least one subpixel type of the detector array that is sensitive to the third radiation. In other words, the thermal image is encoded onto the position of the light from the internal light source on the detector array. Thus, the incident thermal radiation modulates the position of the internal radiation on the detector array.

For example, the micromirror array comprises an optical lever or cantilever with at least two layers of different materials to form a bimaterial, for example a bimetallic thermal detector. On the side of the micromirror array facing away from the second radiation, the mirror elements may be provided with a coating that reflects the third radiation of the internal light source. For example, the coating comprises gold.

Thus a single detector array is sufficient to simultaneously obtain visible and thermal images so that there is no need to provide two different cameras, i.e. one camera for thermal and one camera for visible radiation. The use of two camera systems would translate to higher system cost, a bulky system and increased power consumption. In addition, two camera systems would cause a further software burden for identifying features within the images for overlap of the visible and thermal images. According to the present application in contrast, simultaneous visible and thermal imaging using the same detector array and the same readout circuit simplifies the overall system. This reduces cost, size and power consumption while allowing for simplified readout and highly accurate overlap between visible and thermal images.

According to at least one embodiment of the imaging device, the first radiation includes radiation in the visible spectral range. For example, the detector array comprises subpixels for the red spectral range, the green spectral range and the blue spectral range. The detector array may also include subpixels that are sensitive to ultraviolet or near infrared radiation. These subpixels may be sensitive to ultraviolet or near infrared radiation only or to visible radiation as well as ultraviolet or near infrared radiation.

According to at least one embodiment of the imaging device, the second radiation includes thermal radiation. In particular, the thermal radiation includes radiation with a wavelength between 7 μm and 14 μm inclusive.

According to at least one embodiment of the imaging device, the at least one subpixel type configured to detect the third radiation is sensitive to at least part of the first radiation as well. Thus, the at least one subpixel type can be used for the detection of part of the first radiation and for the detection of the third radiation. Two or more subpixel types or even all subpixel types may be sensitive to the third radiation. This helps to increase the spatial resolution for the detection of the third radiation.

According to at least one embodiment of the imaging device, the at least one subpixel type configured to detect the third radiation is insensitive to the first radiation. For example, the at least one subpixel type is provided in addition to subpixel types that are configured to detect the first radiation.

According to at least one embodiment of the imaging device, at least one subpixel type is configured to detect near infrared radiation included in the first radiation. Thus, this subpixel type may be used to directly obtain an NIR image. For example, this subpixel type is insensitive to the third radiation of the internal light source. For example, the imaging device comprises two different subpixel types that are sensitive to two different wavelengths in the near infrared. For example, a difference between two peak detection wavelengths in the near infrared is at least 50 nm or at least 100 nm. For example, one subpixel type is configured to directly detect near infrared radiation included in the first radiation and a further subpixel type is configured to detect near infrared radiation from the internal light source.

According to at least one embodiment of the imaging device, the imaging device comprises a first lens configured to direct the first radiation onto the detector array and/or a second lens configured to direct the second radiation onto the micromirror array. In particular the first lens and the second lens are arranged side by side in a top view of the imaging device. In other words, the first lens and the second lens do not overlap in top view onto the imaging device. In particular, the first lens and the second lens are arranged and configured such that they image the same scene.

The first lens and/or the second lens may be of a single lens or a multi-lens configuration. The first lens and/or the second lens may be configured as a conventional lens of transmissive bulk material or as a metalens. For example, the metalens may comprise a dielectric material such as titanium dioxide, niobium pentoxide or silicon nitride or a semiconductor material such as silicon or a metal. The metalens may comprise structures like pillars or slots or holes, H, U, V, plus(+) or cross-shaped structures. For example, a height of the structures is between 500 nm and 700 nm. For example, a maximum lateral extent or diameter of the structures is between 40 nm and 400 nm inclusive. For example, a period of the structures is between 180 nm and 450 nm inclusive.

Furthermore, the first lens and/or the second lens may also be a microlens array. The microlenses of the microlens array may also be implemented as metalenses.

In particular the first lens and the second lens are aligned such that they both image the same scene. For example, the first lens and/or the second lens may be coated with an anti-reflector coating for the radiation to be transmitted through the first and/or second lens.

For example the second lens overlaps with the mirror array in top view onto the imaging device. However, the second lens and the micromirror array may be arranged with an offset to aid in a better overlap of the images referring to the first and second radiation.

For example, the second radiation and the third radiation impinge onto the micromirror array from opposite directions.

According to at least one embodiment of the imaging device, a first beam splitter is arranged between the detector array and the first lens and a second beam splitter is arranged between the internal light source and the micromirror array.

For example the first beam splitter and/or the second beam splitter may be configured as a dichroic beam splitter. For example, the first beam splitter is configured to transmit the first radiation and to reflect the third radiation, for example at an angle of incidence of 45°.

According to at least one embodiment of the imaging device, the detector array and the internal light source are mounted side by side on a common substrate. This facilitates a compact design of the imaging device.

According to at least one embodiment of the imaging device, the internal light source is configured to emit the third radiation with a predetermined pattern, for instance a dot pattern.

A comparison between a detected dot pattern on the detector array with a calibrated dot pattern may be used to determine the image belonging to the second radiation.

According to at least one embodiment the internal light source includes an emitter and a dot pattern generator arranged downstream of the emitter.

For example, the dot pattern generator is a diffractive optical element (DOE).

According to at least one embodiment of the imaging device, the internal light source includes an emitter array configured to emit a plurality of individual light beams. For example, the emitter or the emitter array is configured to incoherent or coherent radiation.

If an emitter array is used as an emitter, an additional dot pattern generator may be dispensed with.

According to at least one embodiment of the imaging device, the imaging device is configured to be operable in a low power mode. For example, only a subset of the plurality of subpixels is operated in the low power mode. For example, the subset is a random selection of the subpixels or corresponds to a predefined selection. The subset may include 10% or less, or 5% or less, or 1% or less of the total number of subpixels of the imaging device. The reduced number of operated subpixels allows for significantly reducing the power consumption compared to a regular operation mode where all of the subpixels are operated.

A change of the signal obtained from the selected subset of pixels during the low power mode may trigger a switching into a regular operation mode with increased spatial resolution using all of the subpixels or at least using an increased number of subpixels. For example, the low power mode is used for human presence monitoring or occupation monitoring in the low power mode, for example at thermal wavelengths. This may be followed by a full power mode or an all color mode and/or a thermal imaging mode at full resolution. This helps to enable feature of object detection since color imaging may be captured at better spatial resolution compared to thermal imaging.

According to at least one embodiment of the imaging device, only one of the subpixel types is operated in the low power mode. For example, only the subpixel type configured to detect the third radiation is operated in the low power mode. Thus, a change in the second radiation, for example thermal radiation, causing a change in the deflection of one or more of the mirror elements, may trigger the switching into the regular operation mode. However, in other embodiments two or more subpixel types may be operated in the low power mode.

For example, at least two subpixels associated with one mirror element are operated in the low power mode. This may apply for all of the mirror elements or at most 90% or at most 70% or at most 50% and/or for at least 0.1% or at least 1% or at least 5% or at least 10% or the mirror elements.

Furthermore a method of multi-spectral imaging is specified. The method can be performed using the imaging device described above. Thus, features described in connection with the imaging device may also apply for the method and vice versa.

According to at least one embodiment of the method, the method comprises the step of providing an imaging device comprising a detector array with a plurality of pixels, the pixels comprising a plurality of subpixel types. The imaging device further comprises a micromirror array with a plurality of mirror elements configured to deflect in response to a second radiation and an internal light source.

According to at least one embodiment of the method, the method includes the step of obtaining a first image using at least one subpixel type responsive to a first radiation. For example, the first image is a full-color image in the visible spectral range.

According to at least one embodiment of the method, the method comprises the step of illuminating the micromirror array with a third radiation emitted by the internal light source.

According to at least one embodiment of the method, the method includes the step of detecting the third radiation reflected by the micromirror array using at least one subpixel type responsive to the third radiation.

According to at least one embodiment of the method, the method includes the step of obtaining a second image corresponding to the second radiation based on the detected third radiation.

In at least one embodiment the method of multi-spectral imaging includes the steps of:
a) providing an imaging device comprising:
   a detector array with a plurality of pixels, the pixels comprising a plurality of subpixel types,
   a micromirror array with a plurality of mirror elements, the mirror elements being configured to deflect in response to a second radiation, and
   an internal light source;
b) obtaining a first image using at least one subpixel type responsive to a first radiation;
c) illuminating the micromirror array with a third radiation emitted by the internal light source;
d) detecting the third radiation reflected by the micromirror array using at least one subpixel type responsive to the third radiation; and
e) obtaining a second image corresponding to the second radiation based on the detected third radiation.

With the method described, the first image and the second image may be obtained by a common detector array even though the photosensitive material of the detector array itself would not be able to detect the second radiation. For example, the method allows a first image to be obtained in the visible spectral range and a thermal image to be obtained as a second image using the same detector array.

According to at least one embodiment of the method, the step of obtaining the second image includes comparing a detected dot pattern of the third radiation with a calibrated dot pattern. For example, the calibrated dot pattern refers to a situation where the micromirror array is exposed to second radiation with predefined spatial characteristics. According to at least one embodiment of the method, the step of obtaining the second image includes determining an intensity of the second radiation for the pixels of the detector array based on deviations between the detected dot pattern and the calibrated dot pattern.

According to at least one embodiment of the method, the steps of obtaining the first image and illuminating the micromirror array with the third radiation are performed simultaneously using different subpixel types for the first and the third radiation. For example, at least one subpixel type of the detector array is configured to be sensitive to the third radiation but not to the first radiation.

According to at least one embodiment of the method the steps of obtaining the first image and illuminating the micromirror array with the third radiation are performed using time-multiplexing based on at least one subpixel type for the first and the third radiation.

For example, the internal light source is operated in pulsed on/off operation so that the on times may be used to detect the third radiation impinging onto the detector array to obtain the second image and the off times may be used to obtain the first image.

Further features and expediencies will become apparent from the following description of the exemplary embodiments in connection with the figures.

In the exemplary embodiments and figures similar or similarly acting constituent parts are provided with the same reference signs. Generally only the differences with respect to the individual exemplary embodiments are described. Unless specified otherwise, the description of a part or aspect in one embodiment applies to a corresponding part or aspect in another embodiment as well.

### BRIEF DESCRIPTION OF THE DRAWINGS

In the figures:

FIG. 1 shows an exemplary embodiment of an imaging device;

FIG. 2 shows a schematic representation of the imaging device operation according to an exemplary embodiment;

FIG. 3 shows an exemplary embodiment of a micromirror array;

FIGS. 4A and 4B show an exemplary embodiment of a mirror element in top view (FIG. 4A) and in side view (FIG. 4B);

FIG. 4C and 4D show an exemplary embodiment of a mirror element in top view (FIG. 4C) and in side view (FIG. 4D);

FIGS. 5A and 5B show an exemplary embodiment of a calibrated dot pattern (FIG. 5A) and a corresponding detected dot pattern (FIG. 5B) during operation;

FIG. 6 shows an exemplary embodiment of an imaging device;

FIG. 7 shows an exemplary embodiment of an imaging device;

FIG. 8 shows an exemplary embodiment of an imaging device;

FIG. 9 shows an exemplary embodiment of an imaging device;

FIG. 10A shows an exemplary embodiment of a filter array with corresponding transmission curves for the filters as a function of the wavelength λ in FIG. 10B;

FIG. 11A shows an exemplary embodiment of a filter array with corresponding transmission curves for the filters as a function of the wavelength λ in FIG. 11B;

FIG. 12A shows an exemplary embodiment of a filter array with corresponding transmission curves for the filters as a function of the wavelength λ in FIG. 12B;

FIG. 13A shows an exemplary embodiment of a filter array with corresponding transmission curves for the filters as a function of the wavelength λ in FIG. 13B;

FIG. 14 shows an exemplary embodiment of a method of multispectral imaging.

### DETAILED DESCRIPTION

The elements illustrated in the figures and their size relationships among one another are not necessarily true to scale. Rather, individual elements or layer thicknesses may be represented with an exaggerated size for the sake of better representability and/or for the sake of better understanding.

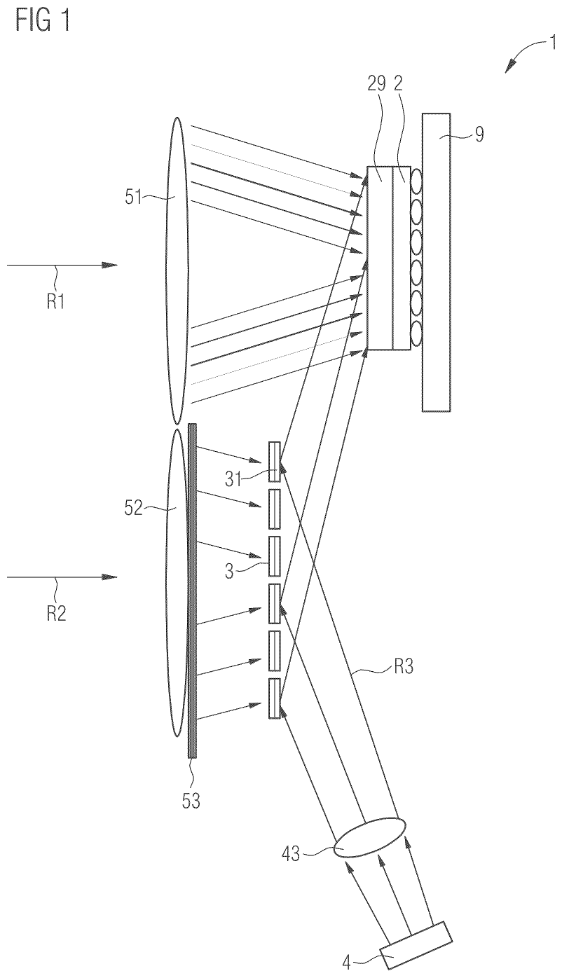

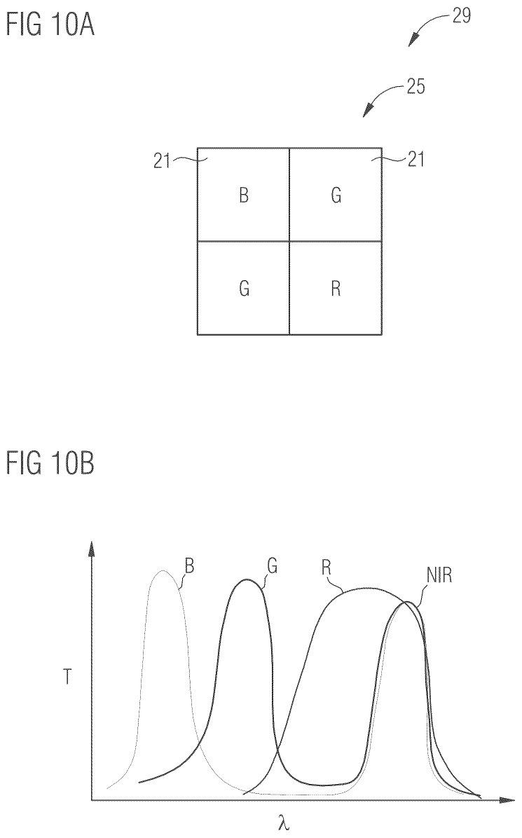

An exemplary embodiment of an imaging device 1 is schematically illustrated in FIG. 1. The imaging device 1 comprises a detector array 2 with a plurality of pixels 25 wherein the pixels 25 each comprise a plurality of subpixel types 21. A filter array 29 is arranged on the detector array in order to obtain different spectral sensitivity distributions for the subpixel types 21. For easier representation the pixels and subpixels are not explicitly shown in FIG. 1. Possible arrangements of subpixels 21 within the pixels 25 are described in connection with FIGS. 10A to 13B.

The imaging device 1 further comprises a micromirror array 3 with a plurality of mirror elements 31. The micromirror array 3 may be one-dimensional or two-dimensional.

The imaging device 1 further comprises internal light source 4.

At least one of the subpixel types 21, for example three subpixel types, is/are configured to detect a first radiation R1. For example, one subpixel type 21 is configured to detect radiation in the blue spectral range, one subpixel type 21 is configured to detect radiation in the green spectral range and one subpixel type 21 is configured to detect radiation in the red spectral range.

The radiation R1 is directed onto the detector array 2 using a first lens 51. The first lens 51 is illustrated as a single lens in FIG. 1, but it may also comprise two or more lenses.

The imaging device 1 further comprises a second lens 52 arranged laterally beside the first lens 51. The second lens 52 is configured to direct a second radiation R2, for example radiation in the longwave infrared range onto the micromirror array 3.

The first lens 51 and/or the second lens 52 may be of a single lens or a multi-lens configuration. The first lens 51 and/or the second lens 52 may be configured as a conventional lens of transmissive bulk material or as a metalens. For example, the metalens may comprise a dielectric material such as titanium dioxide, niobium pentoxide or silicon nitride or a semiconductor material such as silicon or a metal. The metalens may comprise structures like pillars or slots or holes, H, U, V, plus(+) or cross-shaped structures. For example, a height of the structures is between 500 nm and 700 nm inclusive. For example, a maximum lateral extent or diameter of the structures is between 40 nm and 400 nm inclusive. For example, a period of the structures is between 180 nm and 450 nm inclusive.

Furthermore, the second lens 52 may also be a microlens array. The microlens array may also be implemented as an array of metalenses.

The mirror elements 31 are configured to deflect in response to the second radiation R2. The internal light source 4 is configured to illuminate the micromirror array with a third radiation R3. At least one of the subpixel types 21 is configured to detect the third radiation R3 reflected by the micromirror array 3.

A simultaneous readout of a thermal image belonging to radiation R2 and an optical image belonging to radiation R1 can be obtained from the same detector array 2 which is configured as a CMOS image sensor, for example.

The thermal image is read out from a difference in a spot position of a dot pattern compared to a calibrated dot pattern belonging to a calibrated position of the mirror elements 31.

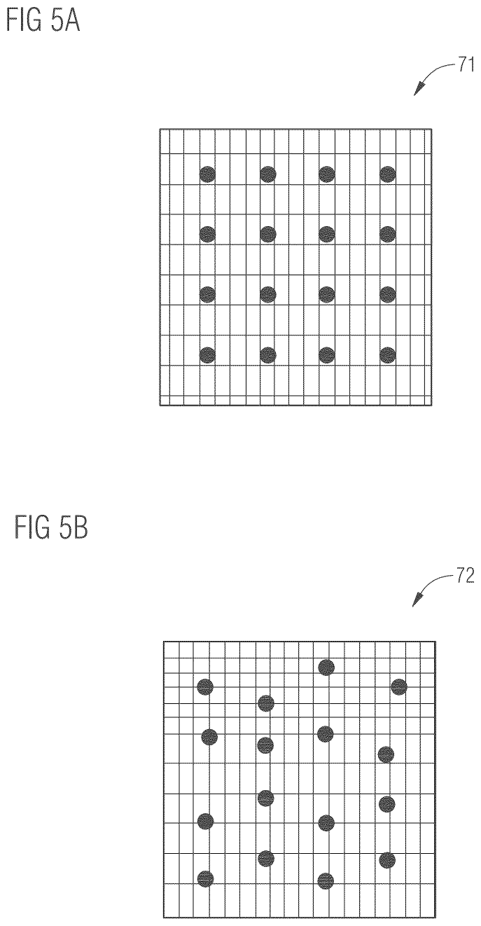

This is illustrated in FIGS. 5A and 5B, showing a calibrated dot pattern 71 in FIG. 5A and a corresponding detected dot pattern 72 in FIG. 5B which is detected during regular operation. The thermal energy of the second radiation R2 causes the mirror elements 31 of the micromirror array 3 to bend. The difference in the individual spot positions of the dot pattern on the detector array 2 allows the corresponding thermal image belonging to the second radiation R2 to be calculated.

As shown in FIG. 1, a lens 43 may be placed between the internal light source 4 and the micromirror array 3. This facilitates obtaining sharp spots on the detector array 2, resulting in an improved quality of the obtained thermal image.

For example, the internal light source 4 emits with a peak emission wavelength in the near infrared range so that the detector array 2 with a photosensitive region based on silicon is able to detect the third radiation R3.

However, the internal light source 4 may also emit in a different spectral range, for instance in the ultraviolet range as long as the radiation can be detected by at least one subpixel type 21 of the detector array 2.

In the exemplary embodiment of FIG. 1, an optical filter 53 is arranged in the beam path of the second radiation R2 on its way to the micromirror array 3, for example downstream of the second lens 53. For example, the optical filter 3 transmits radiation in the longwave infrared range and blocks radiation in the visible range. However, such an optical filter 53 is optional. This likewise applies to all further subsequently described exemplary embodiments.

The imaging device 1 uses two lenses, namely the first lens 51 and the second lens 52, to create separate imaging channels for the first radiation R1, for example visible radiation, and the second radiation R2, for example thermal radiation in the longwave infrared spectral ranges. The first lens 51 and the second lens 52 are spaced apart from one another and designed and aligned such that they both image the same scene.

The first lens 51 and/or the second lens 52 may be optionally coated with an anti-reflector coating for better performance in the respective spectral range. The optical filter 53 may be used to block any radiation other than the longwave infrared radiation from impinging on the micromirror array 3.

For example, the mirror elements 31 are cantilevers. The optical filter 53 may help to reduce the measurement noise in the longwave infrared image.

The first lens is placed above the detector array 2 to form an imaging path for the first radiation R1, for example visible radiation in the spectral range between 400 nm and 700 nm. The first radiation R1 to be detected may further include radiation in the near infrared spectral range.

The first lens 51 may be placed directly above the detector array 2 or with an offset to satisfy design conditions to align both the images belonging to the first R1 and the second radiation R2 respectively. The captured visible images belonging to the first radiation R1 may serve as a frame of reference to setup and/or align the imaging assembly used to detect the second radiation R2.

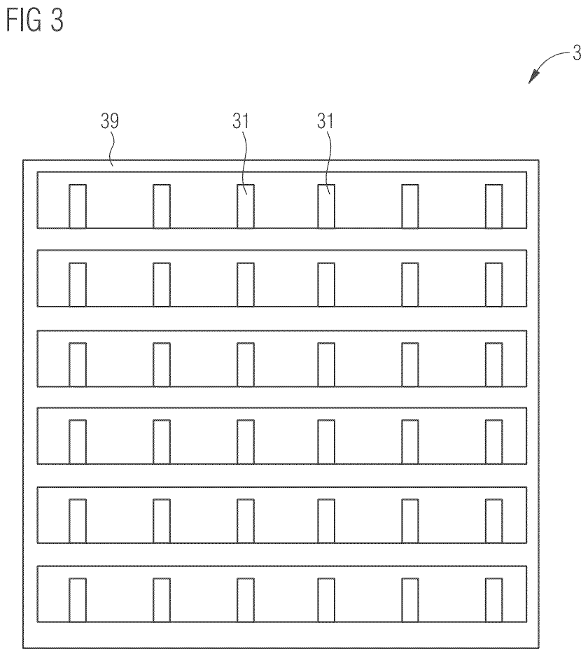

An exemplary embodiment of a micromirror array 3 is illustrated in FIG. 3. The mirror elements 31 are micro cantilevers arranged in a rectangular grid. The mirror elements 31 each extend away from a frame 39 and are free to reflect in response to impinging thermal radiation. Thus, the mirror elements 31 represent micro-optomechanical (MOM) devices such as bimaterial micro-cantilevers, for instance bimetallic micro-cantilevers.

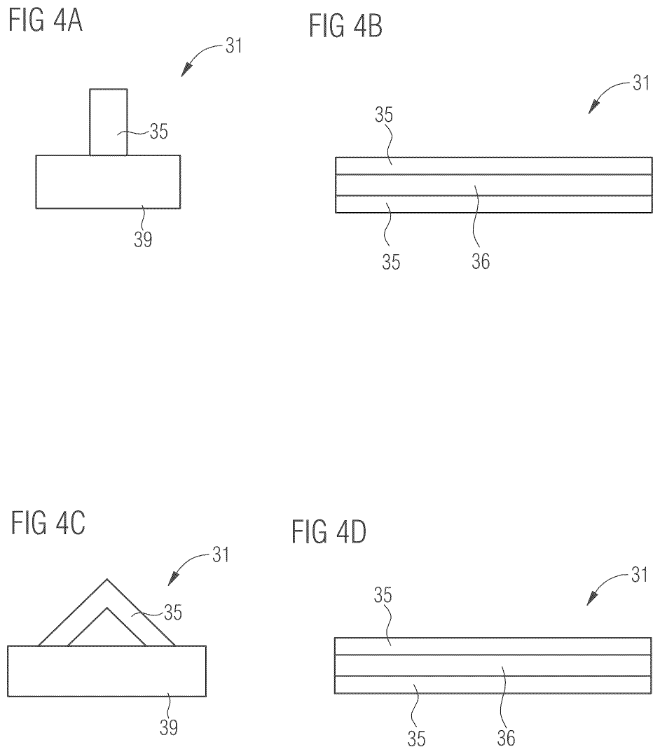

The size and the pitch of the mirror elements 31 is determined by the required resolution and sensitivity of the image belonging to the second radiation, for instance a thermal image. The mirror elements 31 may also be arranged one-dimensionally in a row. Further details of the mirror elements 31 are described in connection with FIGS. 4A to 4D.

The light of the internal light source 4, i.e. the third radiation R3 is illuminated on the side of the micromirror array 3 facing away from the second lens 52. The third radiation R3 is reflected by the micromirror array 3 onto the detector array 2.

When the side of the mirror element 31 facing the second lens 52 is illuminated by radiation R2, for example thermal energy, the mirror elements 31, for example cantilevers, bend, thereby deflecting the spots of the third radiation R3 to a different position on the detector array 2. This is illustrated in FIGS. 5A and 5B which show how the arrangement of the spots on the detector array 2 changes as a response to the incident thermal energy mediated by the bending of the micro-cantilever array in response to the incident thermal energy. By tracking the change in position of each spot with time, the thermal image can be reconstructed simultaneously with the visible image from the same detector array 2. The sensitivity of the micromirror array and overall path length of the deflected internal light determines the limits of the movement of the spots on the detector array 2.

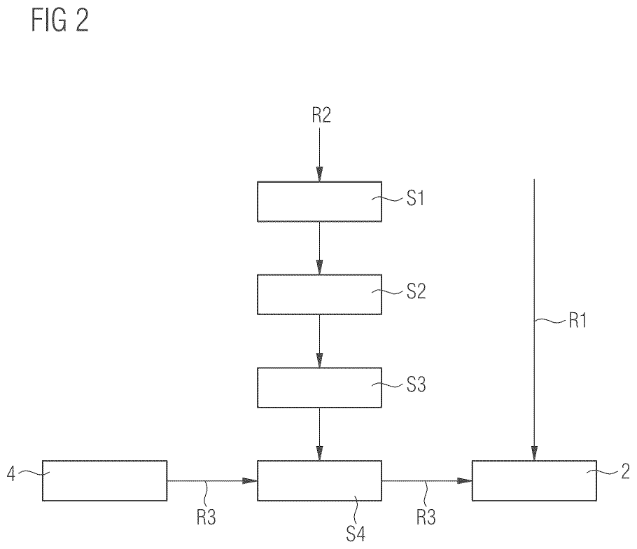

FIG. 2 schematically represents a summary of the operation of the device. The detector array 2 is illuminated by radiation R1 from the scene, for instance visible light. Second radiation R2, for instance in the longwave infrared radiation, from the same scene is focused on the micromirror array (block S1). This causes the mirror elements 31 to bend (block S2). Thus the longwave infrared radiation causes the mirror elements 31 to bend (block S3). The micromirror array 3 is irradiated by radiation R3 from an internal light source 4. The deflected third radiation R3 impinges onto the detector array 2, where at least one type of subpixel 21 is sensitive to the radiation R3 of the internal light source 4.

FIGS. 4A to 4D illustrate exemplary embodiments of possible mirror elements 31 in top view (FIGS. 4A and 4C) and in side view (FIGS. 4B and 4D). The mirror elements 31 comprise a first material 35 and a second material 36. The frame is likewise made from the second material 36. For example the first material is gold and the second material is silicon and/or silicon nitride. Other materials may likewise be used as first and second material as long as there is a sufficient difference in the thermal coefficient of linear expansion for the materials used. In the exemplary embodiment illustrated in FIG. 4A the mirror element 31 essentially has a rectangular shape that extends away from the frame 39. In the exemplary embodiment of FIG. 4C the mirror element 31 has a triangular shape.

The geometry of the mirror elements 31 may be modified in wide limits as long as impinging thermal energy results in a deflection of the mirror element 31.

Optionally, the imaging device 1 is configured to be operable in a low power mode. For example, only a subset of the plurality of subpixels is operated in the low power mode. For example, the subset is a random selection of the subpixels or corresponds to a predefined selection. The subset may include 10% or less, or 5% or less, or 1% or less of the total number of subpixels of the imaging device 1. The reduced number of operated subpixels allows for a significant reduction of the power consumption compared to a regular operation mode where all of the subpixels are operated. If, for example, a 40×40 matrix of pixels 25 is assigned to one mirror element 31, the number of activated pixels during the low power mode may be 10 or less, for example 2, 3, 5 or 8, so that less than 1% of the pixels assigned to the mirror element 31 are operated in the low power mode. Of course, the number of mirror elements 31, the number of pixels 25 assigned to one mirror element 31, and the number of pixels per mirror element 31 activated during the low power mode may be varied within broad limits.

For example, only the subpixel type sensitive to the third radiation R3 is operated in the low power mode, so that a change in the thermal radiation, for example due to an approaching animal or human being can trigger a switching into the regular operation mode, for example to perform resolution imaging in mono or full color so as to now enable high quality imaging for object identification, recognition, etc. The low power mode can be used for human presence monitoring, in particular followed by imaging, for instance.

However, in addition to or instead of thermal radiation, radiation in the visible spectral range may also be detected in the low power mode and trigger a switching event using the respective subpixel types.

The described low power mode may also apply for the further exemplary embodiments.

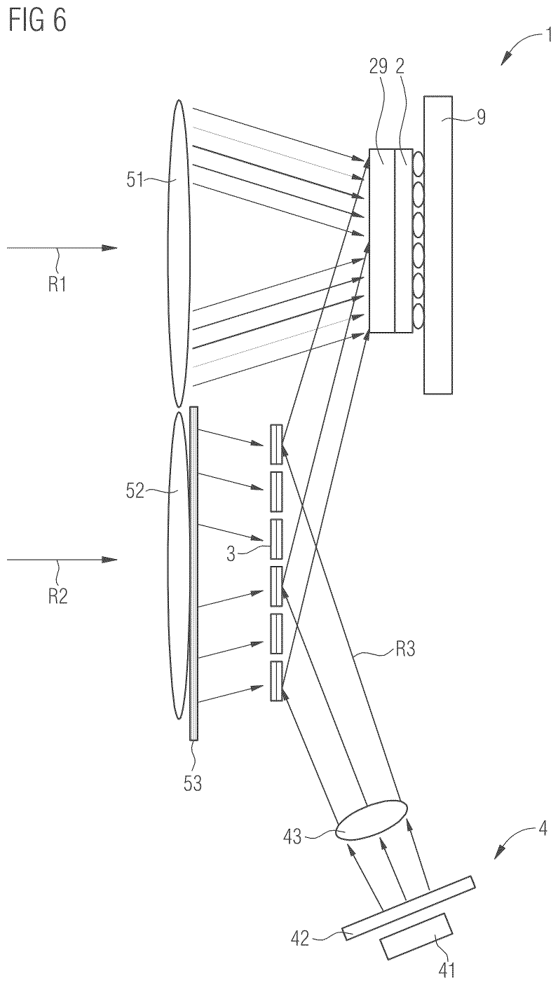

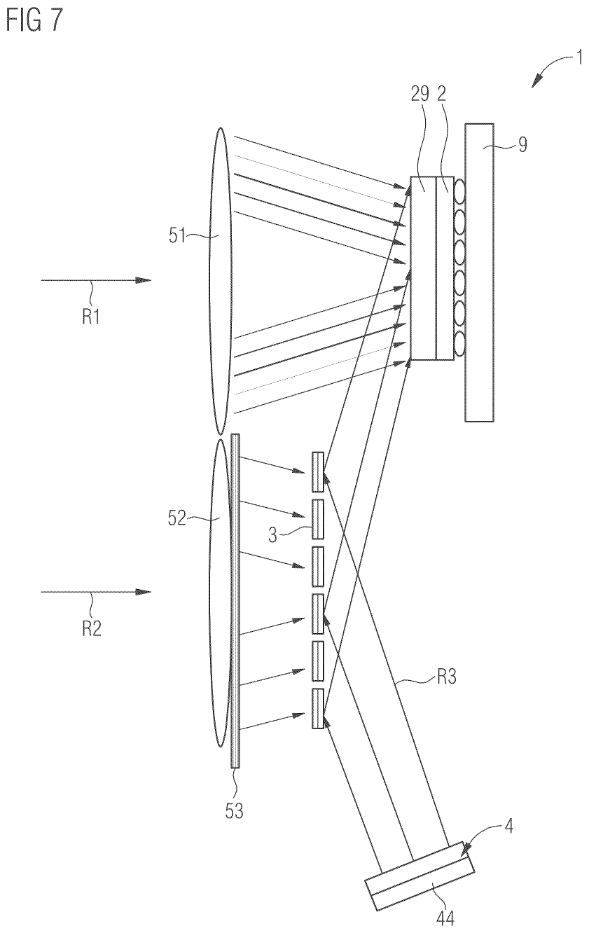

The exemplary embodiments illustrated in FIGS. 6 and 7 differ in the way a radiation pattern is formed for the third radiation R3 provided by the internal light source 4. In the exemplary embodiment of FIG. 6 the internal light source 4 comprises an emitter 41. The emitter 41 produces a uniform illumination that illuminates a dot pattern generator 42, such as a diffractive optical element.

In the exemplary embodiment of FIG. 7, the emitter of the internal light source 4 is an emitter array 44 that produces an array of collimated light beams. For example, the emitter array 44 is an array of laser diodes or vertical cavity surface emitting laser (VCSEL) diodes. In this case an additional dot pattern generator may be dispensed with.

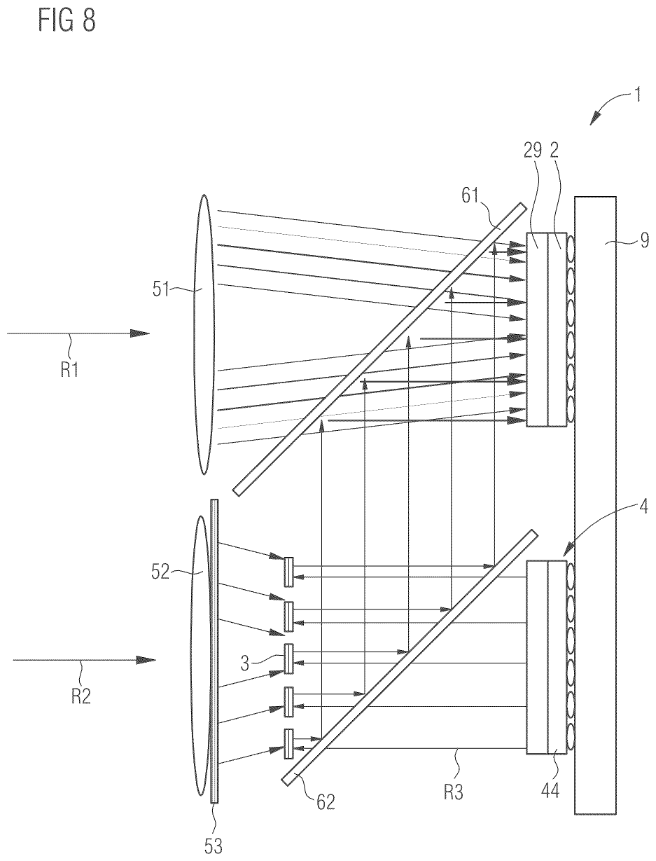

The exemplary embodiment of FIG. 8 essentially corresponds to the embodiments described in connection with FIGS. 1, 6 and 7. Here, the internal light source 4 and the detector array 2 are arranged on a common substrate 9. For example, the internal light source 4 and the detector array 2 are configured as surface mounted devices.

Unlike in the previous exemplary embodiments, the imaging device 1 further comprises a first beam splitter 61 arranged between the detector array 2 and the first lens 51 and a second beam splitter 62 arranged between the internal light source 4 and the second lens 52. This results in a very compact setup of the imaging device 1 so that the imaging device is also suited for use in handheld devices such as smartphones or for home automation devices that require implementation in compact packages.

The first beam splitter 61 and/or the second beam splitter 62 may be embodied as dichroic or non-dichroic beam splitters. For example, the first beam splitter 61 is configured such that it allows for passage of the first radiation R1, for example visible radiation, and for reflection of the third radiation R3 which may have a longer wavelength than the first radiation R1. The angle of incidence on the first beam splitter 61 is about 45° for the first radiation R1 as well as for the third radiation R3.

As shown in FIG. 8, the third radiation R3 emitted by the internal light source 4 illuminates the micromirror array 3 through the second beam splitter 61. The radiation reflected by the micromirror array 3 is reflected at least in part by the second beam splitter 62 and subsequently by the first beam splitter 61 so that it impinges onto the detector array 2. The first radiation R1 is transmitted through the first beam splitter 61 and impinges onto the detector array 2 as well.

For example, the first beam splitter 61 and the second beam splitter 62 are arranged at an angle of 45° with respect to a mounting side of the substrate 9.

For example, the first beam splitter 61 and/or the second beam splitter 62 are implemented as thin film coatings on suitable substrates.

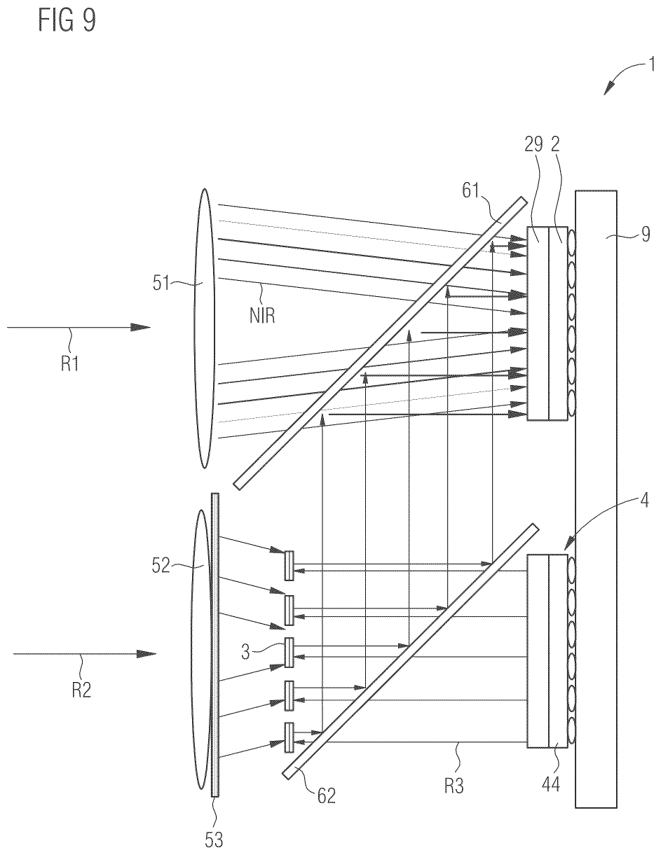

The exemplary embodiment shown in FIG. 9 essentially corresponds to that of FIG. 8.

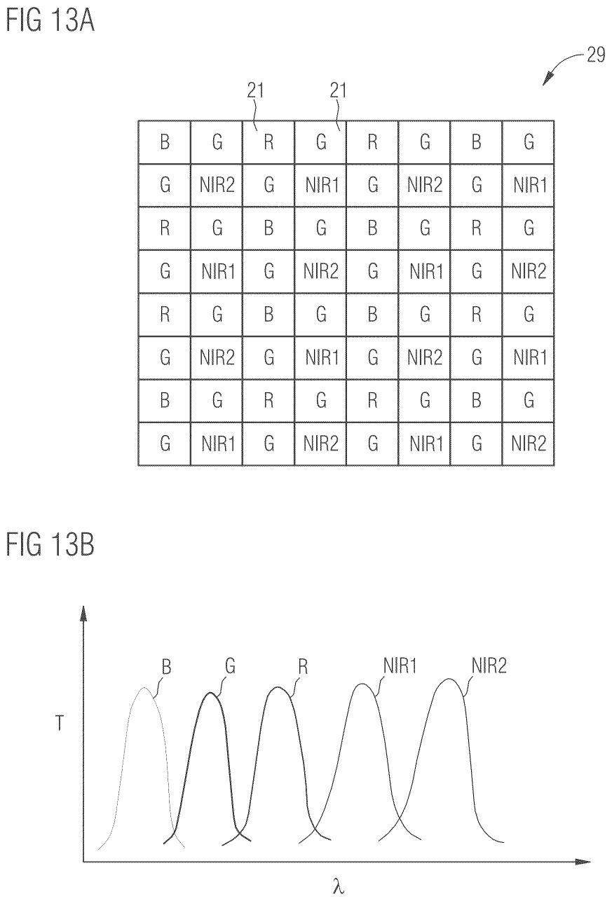

In this exemplary embodiment the detector array 2 is configured to detect near infrared portions of the first radiation R1 (labelled NIR in FIG. 9). Consequently, the imaging device 1 may provide a full color image for the visible radiation, a second image for the radiation R2 in the longwave infrared range and a third image belonging to the near infrared radiation NIRI of the first radiation R1. An example of a suitable filter array is described in connection with FIGS. 13A and 13B.

Direct detection of near infrared radiation may also be used for the exemplary embodiments described in connection with FIGS. 1, 6 and 7.

FIG. 10A, together with FIG. 10B, illustrates an exemplary embodiment of a filter array 29 for the detector array 2. In this exemplary embodiment the detector array 2 comprises three different subpixel types 21 for detecting radiation in the blue spectral range (labelled B), in the green spectral range (labelled G) and in the red spectral range (labelled R). The three subpixel types 21 are arranged in the so-called Bayer mosaic pattern (BGGR) having one subpixel for blue radiation, one subpixel for red radiation and two subpixels for green radiation.

As illustrated in the transmission curves of FIG. 10B, the color filter transmitting the red radiation also transmits the third radiation R3 in the near infrared range emitted by the internal light source 4. The blue color filter B and the green color filter G likewise transmit in the near infrared wavelength regime NIR. Thus, the transmission curves of the blue color filter and the green color filter have two transmission maxima spectrally spaced from one another.

With this filter array 29, near infrared light emitted by the internal light source 4 can be detected by all of the subpixel types 21. This allows for a high-resolution detection of the radiation pattern of the third radiation R3 impinging onto the detector array 2.

In this configuration the internal light source 4 may be operated in pulsed (on/off) operation at a certain frequency. When the internal light source 4 is off, then no third radiation R3 of the internal light source 4 is present on the detector array so that during this timeframe the detector array 2 will only record the images for the radiation R1, for instance in the visible spectral range. When the internal light source 4 in the near infrared is on, then the near infrared spots appear on the detector array. During this timeframe, the imaging device 1 records the changes in the near infrared spot location, thereby estimating the thermal images. Thus, in the on/off cycle the imaging device 1 is able to record both the first image in the visible range and the second image in the thermal range in quick succession. This approach is particularly suited for cost and/or power sensitive applications.

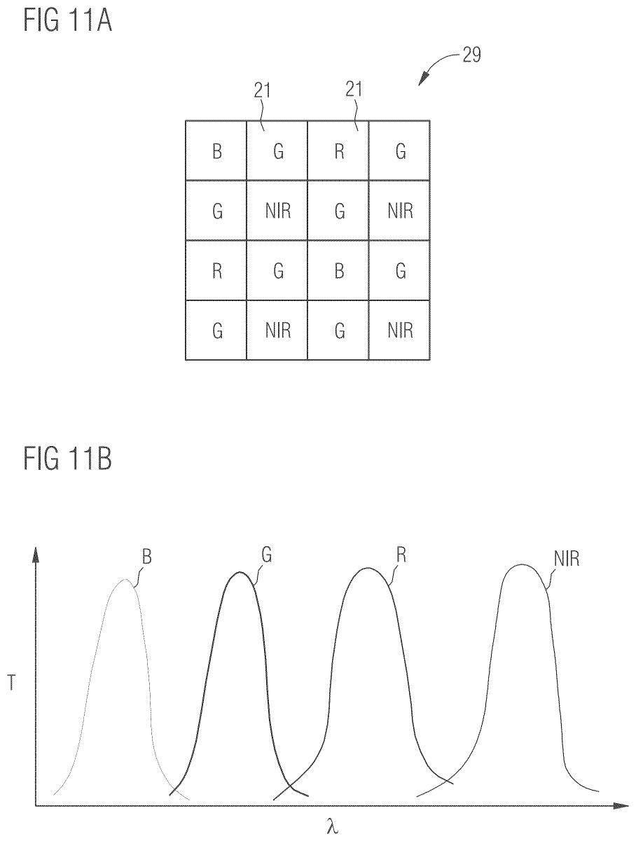

In the exemplary embodiment shown in FIGS. 11A and 11B, the detector array 2 comprises an additional subpixel type 21 which is sensitive for the radiation of the internal light source 4 in the near infrared spectral range (labelled NIR). In this implementation all color channels are available at the same time so that the imaging device 1 performs capturing of both thermal and visible images. Such an implementation allows for high frame rate applications.

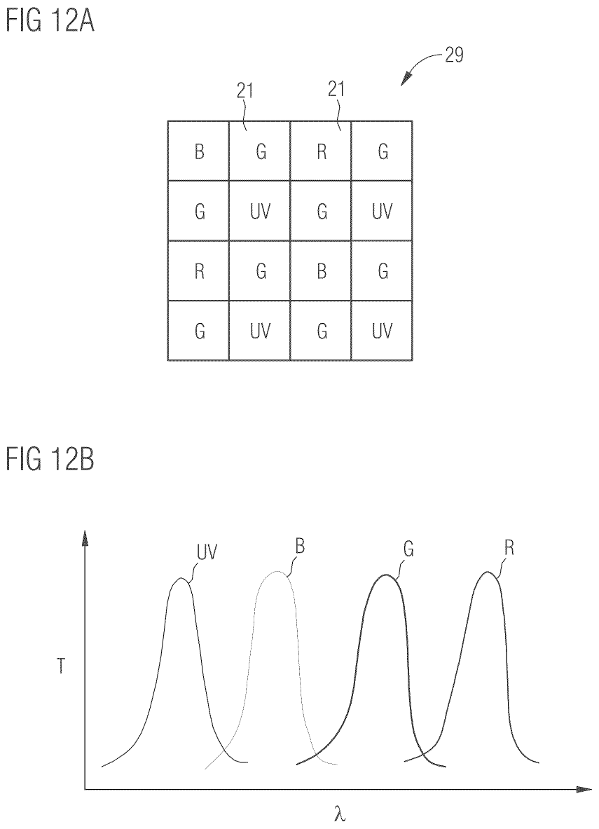

The exemplary embodiment shown in FIGS. 12A and 12B essentially corresponds to that of FIGS. 11A and 11B.

In contrast to the previous exemplary embodiment, the internal light source 4 does not emit in the near infrared spectral range, but rather in the ultraviolet spectral range. Thus, the detector array 2 comprises, in addition to the subpixel types 21 for visible radiation (R, G, B) a subpixel type (UV) to detect ultraviolet radiation.

The exemplary embodiment shown in FIGS. 13A and 13B allows simultaneous imaging to be performed in the visible spectral range, the near infrared range and the longwave infrared range. In addition to the subpixel types 21 for the visible spectral range (R, G, B), a subpixel type NIR1 sensitive in the near infrared and a further subpixel type NIR2 sensitive in the near infrared with a different NIR wavelength are provided. By choosing two NIR channels, one of the channels is dedicated to the thermal imaging via the internal light source 4, while the other NIR channel is dedicated to imaging at NIR wavelength provided in first radiation R1.

For example, a peak wavelength of the internal light source 4 emits at 780 nm, whereas the NIR2 channel is chosen for imaging at a peak detection wavelength of 940 nm. Of course, simultaneous imaging in the visible, the near infrared and the longwave infrared range can also be obtained using an internal light source 4 for emitting in the ultraviolet spectral range as described in connection with FIGS. 12A and 12B. In this case, only one subpixel type 21 sensitive in the NIR is required.

In the exemplary embodiments described above, the detector array and the micromirror array are embodied as two-dimensional arrays. However, the micromirror array 3 and/or the detector array 2 may also be implemented as one-dimensional line scan array.

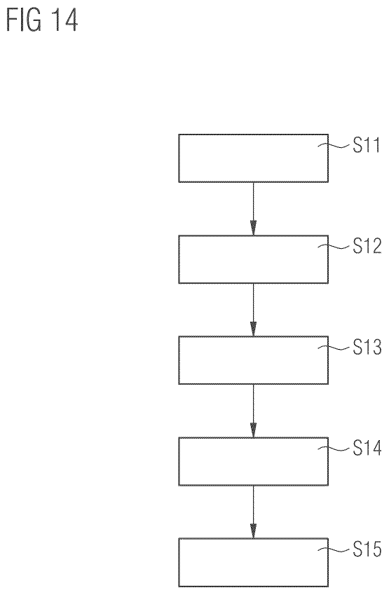

An exemplary embodiment of a method for multi-spectral imaging is illustrated in FIG. 14. A detector array 2 with a plurality of pixels 25 is provided, wherein the pixels comprise a plurality of subpixel types 21. The imaging device 1 further comprises a micromirror array 3 with a plurality of mirror elements 31, wherein the mirror elements 31 are configured to deflect in response to a second radiation R2. The imaging device further comprises an internal light source 4 (step S11).

In a step S12 a first image is obtained using at least one subpixel type responsive to a first radiation R1.

In a step S13, the micromirror array is illuminated with a third radiation R3 emitted by the internal light source 4.

In a step S14 the third radiation R3 reflected by the micromirror array 3 is detected using at least one subpixel type 21 responsive to the third radiation R3.

In a step S15 a second image corresponding to the second radiation R2 is obtained based on the detected third radiation R3.

As described in connection with FIGS. 5A and 5B, the step of obtaining the second image may include comparing a detected dot pattern of the third radiation R3 with a calibrated dot pattern.

The steps S12 and S13 may be performed in the time domain in an alternating manner as described in connection with FIGS. 10A and 10B or simultaneously as described in connection with FIGS. 11A to 13B.

Using the method, first and second images in different spectral ranges, for instance in the visible spectral range and in the longwave infrared range, can be obtained using the same detector array. In addition, a third image in the near infrared spectral range may be provided.

The invention described herein is not restricted by the description given with reference to the exemplary embodiments. Rather the invention encompasses any novel feature and any combination of features including in particular any combination of features in the claims, even if this feature or this combination is not itself explicitly indicated in the claims or exemplary embodiments.

1. An imaging device comprising:
a detector array with a plurality of pixels, the pixels comprising a plurality of subpixel types,
a micromirror array with a plurality of mirror elements, and
an internal light source, wherein
at least one of the subpixel types is configured to detect a first radiation wherein the first radiation includes radiation in the visible spectral range and comes from a scene to be imaged by the imaging device;
the mirror elements are configured to deflect in response to a second radiation,
the internal light source is configured to illuminate the micromirror array with a third radiation;
at least one of the subpixel types is configured to detect the third radiation deflected by the micromirror array.

2. (canceled)

3. The imaging device according to claim 1, wherein the second radiation includes thermal radiation.

4. The imaging device according to claim 1, wherein the imaging device comprises a first lens configured to direct the first radiation onto the detector array and a second lens configured to direct the second radiation onto the micromirror array, the first lens and the second lens being arranged side by side in a top view of the imaging device.

5. The imaging device according to claim 4, wherein a first beam splitter is arranged between the detector array and the first lens, and
wherein a second beam splitter is arranged between the internal light source and the micromirror array.

6. The imaging device according to claim 1, wherein the detector array and the internal light source are mounted side by side on a common substrate.

7. The imaging device according to claim 1, wherein the at least one subpixel type configured to detect the third radiation is sensitive to at least part of the first radiation as well.

8. The imaging device according to claim 1, wherein the at least one subpixel type configured to detect the third radiation is insensitive to the first radiation.

9. The imaging device according to claim 1, wherein at least one subpixel type is configured to detect near infrared radiation included in the first radiation.

10. The imaging device according to claim 1, wherein the internal light source is configured to emit the third radiation with a dot pattern.

11. The imaging device according to claim 1, wherein the internal light source includes an emitter and a dot pattern generator arranged downstream of the emitter.

12. The imaging device according to claim 1, wherein the internal light source includes an emitter array configured to emit a plurality of individual light beams.

13. The imaging device according to claim 1, wherein the imaging device is configured to be operable in a low power mode, wherein only a subset of the plurality of subpixels is operated in the low power mode.

14. The imaging device according to claim 13, wherein only one of the subpixel types is operated in the low power mode.

15. A method of multi-spectral imaging comprising including
a) providing an imaging device comprising:
a detector array with a plurality of pixels, the pixels comprising a plurality of subpixel types,
a micromirror array with a plurality of mirror elements, the mirror elements being configured to deflect in response to a second radiation, and
an internal light source;
b) obtaining a first image using at least one subpixel type responsive to a first radiation, wherein the first radiation includes radiation in the visible spectral range and comes from a scene to be imaged by the imaging device;
c) illuminating the micromirror array with a third radiation emitted by the internal light source;
d) detecting the third radiation reflected by the micromirror array using at least one subpixel type responsive to the third radiation; and
e) obtaining a second image corresponding to the second radiation based on the detected third radiation.

16. The method according to claim 15, wherein step e) includes comparing a detected dot pattern of the third radiation with a calibrated dot pattern.

17. The method according to claim 16, wherein step e) includes determining an intensity of the second radiation for the pixels of the detector array based on deviations between the detected dot pattern and the calibrated dot pattern.

18. The method according to claim 15, wherein steps b) and c) are performed simultaneously using different subpixel types for the first radiation and the third radiation.

19. The method according to claim 15, wherein steps b) and c) are performed using time-multiplexing based on at least one subpixel type for the first radiation and the third radiation.

20. The method according to claim 15, wherein the method is performed using an imaging device comprising:
a detector array with a plurality of pixels, the pixels comprising a plurality of subpixel types,
a micromirror array with a plurality of mirror elements, and
an internal light source, wherein
at least one of the subpixel types is configured to detect a first radiation, wherein the first radiation includes radiation in the visible spectral range;
the mirror elements are configured to deflect in response to a second radiation,
the internal light source is configured to illuminate the micromirror array with a third radiation: and
at least one of the subpixel types is configured to detect the third radiation deflected by the micromirror array.

21. The imaging device according to claim 3, wherein the second radiation includes radiation with a wavelength between 7 μm and 14 μm.
